(19) United States
(12) Patent Application Publication
(10) Pub. No.: US 2008/0036505 A1
(43) Pub. Date: Feb. 14, 2008

(54) SEMICONDUCTOR INTEGRATED CIRCUIT DEVICE

(75) Inventor: Norihito KATO, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 11/675,567

(22) Filed: Feb. 15, 2007

(30) Foreign Application Priority Data
Feb. 17, 2006 (JP) 2006-041310

(51) Int. Cl. G05B 13/02

(52) U.S. Cl. 327/16

(57) ABSTRACT

A semiconductor integrated circuit device reduces resources of an external memory and an amount of data of test patterns. A semiconductor integrated circuit device comprises: a terminal BSIN to input serial data from a boundary scan register circuit of the former stage, a terminal BSOUT to output the serial data to a boundary scan register circuit of the latter stage, a flip-flop circuit 21 as a first register to store data for a boundary scan and connected to the terminal BSIN, flip-flop circuits 24a and 24b as a second register to store configuration data for an IO circuit and connected to the terminal BSIN, and a selector 27 to select data output from the first register and the second register and output the data to the terminal BSOUT.

### FIELD OF THE INVENTION

This invention relates to a semiconductor integrated circuit device, and particularly relates to a semiconductor integrated circuit device having a boundary scan register to carry out a boundary scan and to configure a configuration of an input/output (IO) circuit.

### BACKGROUND OF THE INVENTION

JTAG circuits based on the JTAG (Joint Test Action Group) standard (IEEE 1149.1) are broadly utilized for testing semiconductor devices. The circuits are used, for example, to confirm proper connections between semiconductor devices or to test IO circuits of semiconductor devices whether they have desired functions and properties after assembly of semiconductor devices on printed board and so forth.

Recently various kinds of IO circuits such as an IO circuit that needs a circuit configuration for data input/output or an IO circuit that requires changing circuit architecture according to a purpose of a semiconductor device are integrated in semiconductor devices. And in the JTAG circuit, even a register to configure such an IO circuit is also integrated in a boundary scan path.

For example, Patent Document 1 discloses a semiconductor integrated circuit device having a boundary scan resister as a resister to configure an IO circuit architecture of the semiconductor device and the boundary scan register is connected to a boundary scan path of the JTAG circuit. In this device, a configuration circuit for the IO circuit architecture is constructed by incorporating a resister for configuring the IO circuit architecture into a scan path serially in the JTAG circuit, or by adding a new dedicated logic circuit as a user's circuit. The boundary scan of the JTAG circuit with a register to configure the IO circuit architecture is used for the purpose of a configuration of the IO circuit architecture at an actual operation, not only for a test.

FIG. 10 shows a schematic structure of a semiconductor integrated circuit device disclosed in Patent Document 1. The semiconductor integrated circuit device 1 includes pads PD1 to PD14 located along a peripheral portion and cells C1 to C14 corresponding to the pads PD1 to PD14, respectively. Each of the cells C1 to C14 includes input/output cell (IO cells to input and/or output signals from to the pads PD1 to PD14 and a test cell including boundary scan registers corresponding to the IO cells. The boundary scan cells included in the cells C1 to C14 arc connected serially by a scan path 4 and can transmit test data serially. At a normal function mode, the boundary scan registers included in the cells C1 to C14 pass through signals (assume a pass-through state) and the signals are transmitted to/from corresponding buffers (input buffers or output buffers) and internal logic 2.

FIG. 11 shows a block diagram illustrating an example of structure of cells C1 to C14. The boundary scan resistors (BSRs) 101 to 104 are cascaded in series and used as a portion of the scan path 4 at a JTAG test. In FIG. 11, the path from a terminal BSIN to a terminal BSOUT via the BSRs 104 to 101 corresponds to a portion of the scan path 4 in FIG. 10. The BSR 101 and BSR 104 are registers to control circuit architecture of an IO circuit 112 and can change the circuit architecture of the IO circuit 112 by changing data set in the resisters.

Concretely, the IO circuit 112 is provided with an output buffer 106 whose output is connected to a pad 110, a transistor 107 and a pullup resistor 105 connected in series between an output of the output buffer 106 and a power supply, and a transistor 108 and a pulldown resistor 109 connected in series between the output of the output buffer 106 and the ground. The transistor 107 connected to the pullup resistor 105 is controlled on or off by the BSR 101. The transistor 108 connected to the pulldown resistor 109 is controlled its on or off by the BSR 104.

Patent document 1 discloses an example that the BSR 101 and the BSR 104 are contained in a boundary scan chain. On the other hand it is also disclosed that the BSR 101 and the BSR 104 arc not contained in the boundary scan but composed by a dedicated logic circuit. The state of the IO circuit 112 is set (configured) and a test is carried out using the boundary scan. At a normal operation the BSRs 101 to 104 operate so as to pass through data from the IO circuit 112 to the internal logic 2. The BSRs 101 to 104 are controlled by a DC test control circuit 111. The DC test control circuit 111 carries out the DC test by supplying set signal BSRSET or reset signal BSRRST to the BSRs 101 to 104 in response to a received test mode indication signal TESTMODE and a test signal TESTC.

Next the boundary scan register is explained with reference to the figures. FIG. 12A shows a general circuit for boundary scan register recommended by the IEEE 1149.1. The boundary scan register of FIG. 12A is provided with flip-flop circuits (FFs) 201 and 202, and selectors 200 and 203. The FFs 201 and 202 may be latch circuits, too. The boundary scan register is controlled by a ShiftDR signal, a ClockDR signal, an UpdateDR signal and a Model signal output by a TAP (Test Access Port) controller 209 shown in FIG. 12B.

The ShiftDR signal is a switch signal for the selector 200 to select one of input data from a pre-stage register of the boundary scan path via a BSIN terminal and input data from the internal logic 2 via an input terminal. The ClockDR signal is a clock signal for the FF 201 to receive an output signal from the select or 200. The UpdateDR signal is a clock signal to capture data stored in the FF 201 into the FF 202. The Model signal is a switch signal for the selector 203 to select which data from the input terminal or data captured in the FF 203 should be output to an Output terminal.

The TAP controller 209, having an internal instruction register, outputs the ShiftDR signal, the ClockDR signal, the UpdateDR signal and Model signal in response with a configured instruction code in the instruction register to control the boundary scan register and instructs to input/output of test patterns data and to carry out the tests. Five signals of TCK, TMS, TDI, TDO and TRST are prepared for the TAP controller 209 to configure data for the boundary scan register and instruction register and to control the TAP controller.

Instructions to the TAP controller 209 include Public instructions (Public) used by users and Private instructions (Private) used by device venders as shown in FIG. 2. The Public instructions' operations are defined in IEEE 1149.1 and contain BYPASS, SAMPLE, PRELOAD and EXTEST. Besides those, other instructions such as IDCODE, USERCODE, INTEST and RUNBIST can be loaded as options. The Private instructions are defined as particular instructions used for tests of designed circuits or manufacturing tests by a device vender.

Patent Document 2 discloses a test circuit for integrated circuit to execute writing/reading operation in any order for a tested circuit as a related art.
[Patent Document 1]

JP Patent Kokai Publication No. JP-P2000-314765A
[Patent Document 2]

JP Patent Kokai Publication No. JP-P2001-147253A

### SUMMARY OF THE DISCLOSURE

The disclosure of the above Patent Documents are herein incorporated by reference thereto.

Referring to conventional arts, a scan register for an IO circuit configuration (a register to configure or set the circuit structure above mentioned) and a scan register for data of the JTAG test (a register for test data, corresponding to registers BSR 102 and 103 in Patent Document 1) are connected by a single scan path. Therefore, even when data for circuit configuration is transmitted, it is also necessary to transmit the data into a boundary scan register for the JTAG test. For instance, in the circuit shown in FIG. 11, configuration value (design-setting value for configuration) should be transmitted serially to each boundary scan register with data needed for the JTAG test using the boundary scan chain for the purpose of transmission of the configuration value to enable the pullup resistor and the pulldown resistor per each IO circuit.

Circuit configuration data is stored in an external non-volatile memory such as flash memory for such a device as PLD (Programmable Logic Device), and the stored data is transmitted to the PLD device at a starting time of a system. The boundary scan above mentioned can be used to configure the circuit, and the smaller the data size for the circuit configuration, the better because it can economize the resources on the non-volatile memory.

In case to use the conventional boundary scan for the configuration of the circuit in FIG. 11, the boundary scan registers needed to enable the pullup resistor and pulldown resistor are inherently only the BSR 101 and the BSR 104, and data stored in the BSR 102 and the BSR 103 has no meaning whatever the data be. That is to say, the BSR 102 and the BSR 103 are unnecessary registers at a programmable changing state of the circuit. Nevertheless unnecessary data have to be recorded in the non-volatile memory to transmit the BSR 102 and the BSR 103 when the circuit structure as is shown in FIG. 11 is used.

It is possible to carry out a sufficient test easily for a conventional circuit using a combined scan path of a scan register for an IO circuit configuration and a scan register for data needed for the JTAG test. However, when making test patterns, circuit configurations and data for the tests should be set (configured) and therefore it is apprehended that the data for the test patterns will be increased.

On the other hand, to use other dedicated circuit than the JTAG circuit for a register to configure the IO circuit structure, it is necessary to locate a new register in the circuit. Then an overhead and dedicated pins are needed to construct a new logic circuit as an user's circuit.

According to one aspect of the semiconductor integrated circuit device of the present invention, it comprises: a plurality of boundary scan register circuits each having a first register to store data for a boundary scan, a second register to store configuration data for an architecture of an IO circuit connected to an external terminal, and a selection circuit to output one of data selectively from the first register and the second register. The boundary scan register circuit receives data output from the boundary scan register circuit of a preceding stage and inputs the data into the first and the second registers, and then outputs data output from the selection circuit into the boundary scan register circuit of a subsequent stage.

In a second aspect, the selection circuit selects input data based on an operation mode signal.

In a third aspect, the semiconductor integrated circuit device further comprises a test control circuit that controls the first and the second registers and the selection circuit, wherein a transition state of the test control circuit is changed based on an external control signal, and the test control circuit generates an operation clock signal for the first and the second registers and the operation mode signal based on the changed transition state.

In a fourth aspect, the test control circuit functions such that when the first register is selected, the test control circuit does not supply the operation clock signal to the second register, and when the second register is selected, the test control circuit does not supply the operation clock signal to the first register.

In a fifth aspect, the test control circuit further generates an initializing signal, and

the second register is initialized so as to output a predetermined output signal by the initializing signal.

In a sixth aspect, the semiconductor integrated circuit device further comprises a terminator resistance for the external terminal, wherein a connection of the terminator resistance for the external terminal is controlled based on the output data of the second register.

In a seventh aspect, the IO circuit comprises an output circuit having a variable drivability, and the drivability of the output circuit is set based on the output data of the second register.

In an eighth aspect, the output circuit comprises a decoder circuit that decodes the output data of the second register, and the drivability of the output circuit is set by a plurality of output driver transistors which constitute the output circuit and are operated selectively by a decoder output signal from the decoder circuit.

In a ninth aspect, there is provided an electronic apparatus comprising;

a printed circuit board comprising at lease one semiconductor integrated circuit device of the aspects 1 to 8, wherein configuration data for an architecture of an IO circuit connected to the semiconductor integrated circuit device is input from a data input terminal of the printed circuit board.

a boundary scan register circuit present in a circuit of a path on a side of the data input terminal of the semiconductor integrated circuit device is set a bypass-state, and

the data is transmitted to the second register in the semiconductor integrated circuit device.

The meritorious effects of the present invention are summarized as follows.

According to the present invention the semiconductor integrated circuit device stores and transmits data for a boundary scan and data for an IO circuit configuration selectively, it is possible to reduce data volume to be transmitted. Therefore, it is possible to reduce external memory resources and/or test patterns and test time for the JTAG test.

### BRIEF DESCRIPTION OF THE DRAWINGS

FIGS. 1A and 1B show diagrams of a circuit of a main portion of a semiconductor integrated circuit device according to an example of the present invention;

FIG. 2 shows a diagram of an instruction list of a TAP controller;

FIG. 3 shows a block diagram illustrating a structure of a first example of a semiconductor integrated circuit device of the present invention;

FIG. 4 shows a block diagram illustrating a structure of a second example of a semiconductor integrated circuit device of the present invention;

FIG. 5 shows a block diagram illustrating a structure of a third example of a semiconductor integrated circuit device of the present invention;

FIG. 6 shows a block diagram illustrating a structure of a fourth example of a semiconductor integrated circuit device of the present invention;

FIGS. 7A and 7B show block diagrams illustrating a structure of a fifth example of a semiconductor integrated circuit device of the present invention;

FIG. 8 shows a diagram of a logic level example of decord output of a decord circuit;

FIG. 9 shows a block diagram illustrating a structure of an electronic device according to an example of the present invention;

FIG. 10 shows a schematic structure of a semiconductor integrated circuit device;

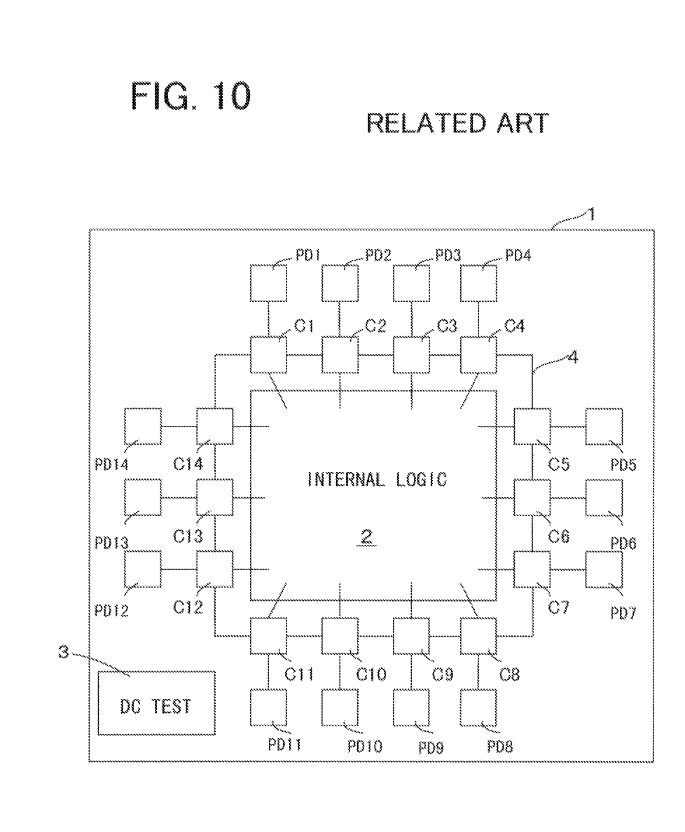

FIG. 11 shows a diagram illustrating a conventional structure of a cell; and

FIGS. 12A and 12B show diagrams illustrating a conventional structure of a boundary scan register and a TAP controller.

### PREFERRED MODES OF THE INVENTION

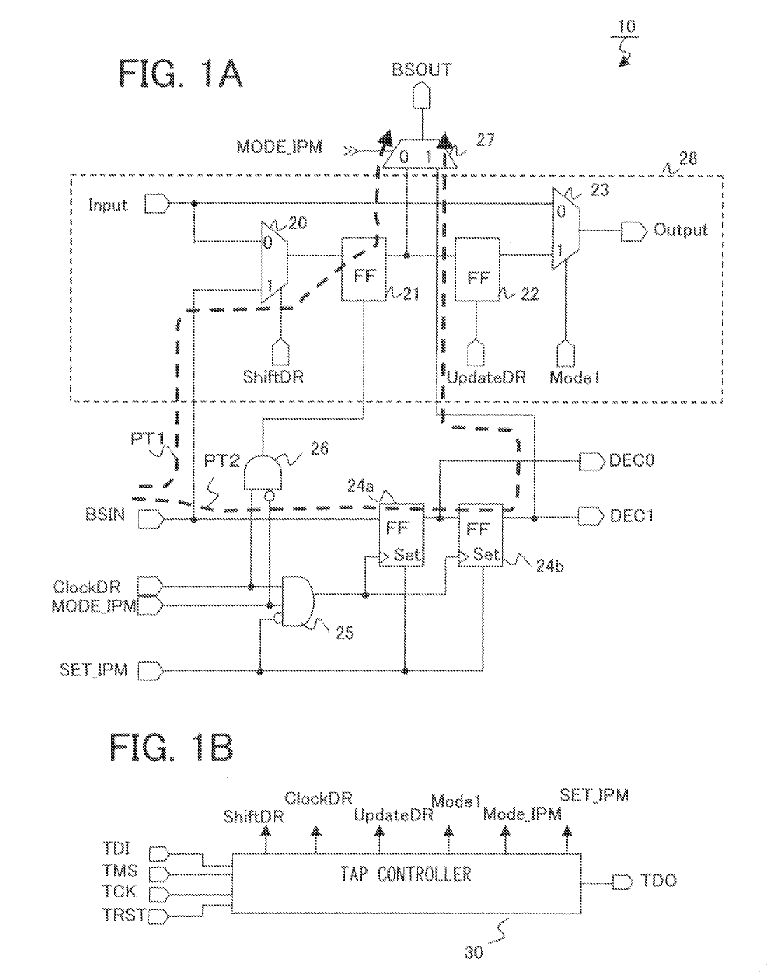

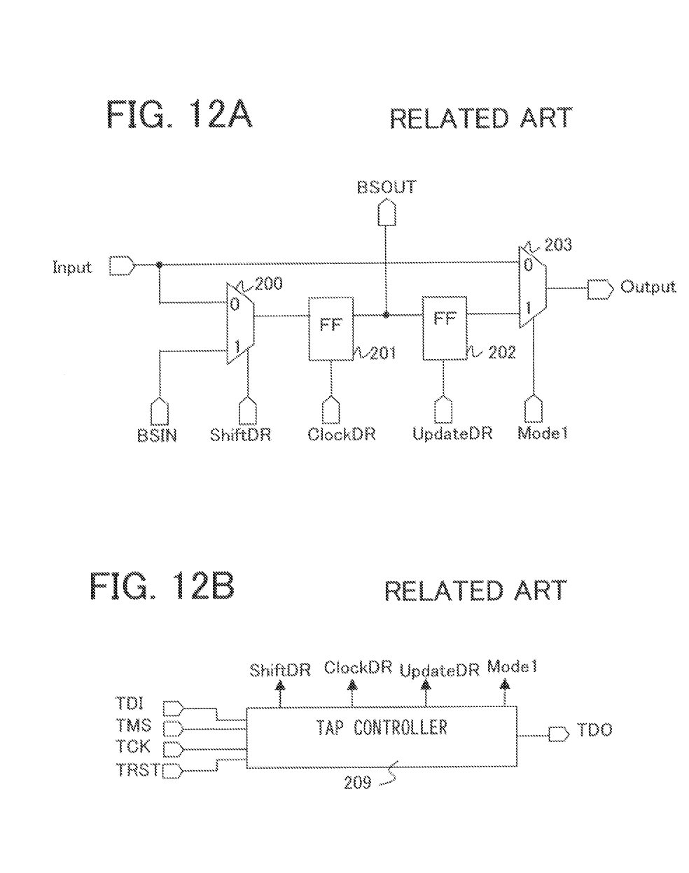

FIGS. 1A and 1B show diagrams of a circuit of a main portion of a semiconductor integrated circuit device according to an example of the present invention. FIG. 1A shows a boundary scan register circuit 10 and FIG. 1B shows a TAP controller 30 to control the boundary scan register circuit 10. The same symbols in FIGS. 1A and 1B as those of FIGS. 12A and 12B indicate the same components. FFs 21 and 22, and selectors 20 and 23 in the boundary scan register circuit 10 are the same as the FFs 201 and 202, and the selectors 200 and 203 in FIG. 12A, respectively. The FFs 21 and 22 may be latch circuits. In FIG. 1A the boundary scan register circuit 10 has a boundary scan register circuit 28 corresponding to the circuit of FIG. 12A and further contains FFs 24a and 24b, gate circuits 25 and 26, and a selector 27.

The FFs 24a and 24b are register circuits to store configuration values to change an IO circuit architecture programmably and a plurality of the FFs can be provided in the boundary scan register circuit according to a bit size necessary to change the IO circuit architecture. Two FFs 24a and 24b are provided in FIGS. 1A and 1B for example. Each of the FF 24a and 24b outputs data DEC0 and DEC1 respectively to configure (or set) the IO circuit architecture. The FFs 24a and 24b with set function are exampled in FIG. 1A.

The boundary scan register circuit 10 is constructed so as to be able to select one of two boundary scan paths PT1 and PT2 using the gate circuits 25 and 26 and the selector 27. The first boundary scan path FT1 constitutes a boundary scan chain through which a test pattern is transmitted at a JTAG test from a terminal BSIN to a terminal BSOUT via the selector 20. FF 21 and selector 27. The second boundary scan path PT2 constitutes a path to transmit configuration data for the IO circuit architecture from the terminal BSIN to the terminal BSOUT via the FF24a, FF24b and selector 27.

The boundary scan register circuit 10 is controlled by signals MODE_IPM and SET_IPM additional to signals ShiftDR, ClockDR, UpdateDR and Mode1. The control by the signals ShiftDR, ClockDR, UpdateDR and Mode1 is almost the same as that of the boundary scan register circuit described in FIGS. 12A and 12B.

The ShiftDR signal is a switch signal supplied to the selector 20 to select one of data input from the preceding stage register of the boundary scan path via the terminal BSIN and data input from an internal circuit of a core region via an terminal Input. The ClockDR signal is a basic signal for clock signals to the FFs 21, 24a and 24b in the boundary scan register circuit and received in the gate circuits 26 and 25 as mentioned hereinafter. The UpdateDR signal is a clock signal to capture data stored in the FF 21 into the FF 22. The Model signal is a switch signal for the selector 23 to select which data from the terminal Input of the boundary scan register circuit 10 or data captured in the FF 22 should be output to a terminal Output.

On the other hand, the MODE_IPM signal is a signal to select one path from the first boundary scan path PT1 or the second boundary scan path FT2 aforementioned. The SET_IPM Signal is a signal to initialize the FFs 24a and 24b as storages of configuration data of the IO circuit. The output of FFs are set 1 when the SET_IPM signal is set high level in FIG. 1A.

The gate circuit 25 is an AND circuit to output a clock signal for the FFs 24a and 24b based on the ClockDR signal, MODE_IPM signal and an inversion signal of the SET_IPM signal. Therefore, an output of the gate circuit 25 is a logical output expressed as ClockDR×MODE_IPM×(SET_IPM)′ where “×” means AND, and “′” means NOT; and the same holds hereafter.

The gate circuit 26 is an AND circuit to output a clock signal for the FF 21 based on the ClockDR signal and an inversion signal of the MODE_IPM signal. Therefore, an output of the gate circuit 26 is a logical output expressed as ClockDR×(MODE_IPM)′.

The selector 27 selects an output of the FF 21 when a signal of the MODE_IPM signal is 0 and selects an output of the FF 24b when a signal of the MODE_IPM signal is 1 and outputs it to the terminal BSOUT.

As to a circuit for controlling the boundary scan register circuit 10, it is possible to use an original circuit or to use a TAP controller adapted to the boundary scan standard of the IEEE 1149.1. A case using the TAP controller 30 is described hereafter as an example.

FIG. 1B shows a block diagram of the structure of the TAP controller 30. The TAP controller 30 outputs the MODE_IPM signal and SET_IPM signal in addition to the ShiftDR signal, ClockDR signal, UpdateDR signal and Model signal. The TAP controller 30 of such a structure can select one of the first boundary scan path PT1 and the second boundary scan path PT2 and put into function according to the JTAG specification. And also it can initialize both FFs 24a and 24b, which are contained in the second boundary scan path PT2, that store data for configuration.

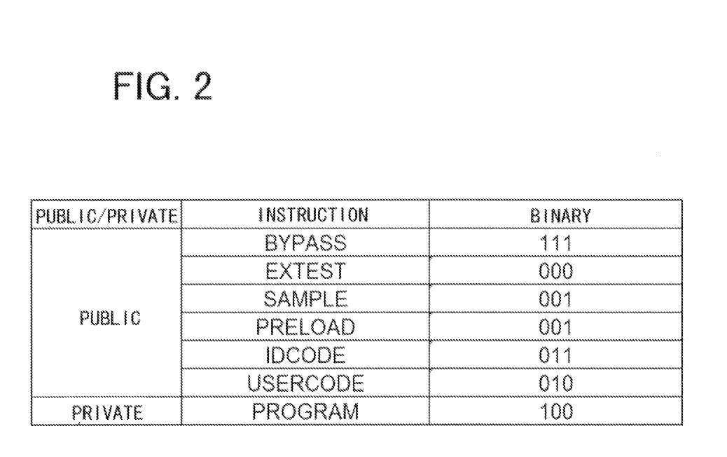

The TAP controller 30 is constructed so as to output a high-level signal to the SET_IPM signal when a low-level signal is input in the terminal TRST. As to instructions by the TAP controller, a new instruction PROGRAM is included in the Private instruction in addition to the Public instructions as shown in FIG. 2. The column at right end of FIG. 2 includes instruction codes of the Public instructions and additional Private instruction in binary numbers.

The TAP controller 30 outputs control signal so as to make a mode of the boundary scan register circuit 10 to store configuration data to configure the IO circuit in the FFs 24a and 24b which construct the second boundary scan path. PT2 when the instruction code “100” (binary number) is stored as the instruction PROGRAM in the TAP controller 30.

The TAP controller 30 sets the MODE_IPM signal high level and SET_IPM Signal low level and configures to store data in the FFs 24a and 24b when the binary number 100 is set in an internal instruction register (not shown). Then the TAP controller 30 functions to store data supplied from a terminal TD1 of the TAP controller 30 into the FFs 24a and 24b. Data supplied from a terminal BSIN is serially transmitted to the FFs 24a and 24b at a time of rising edge of the ClockDR signal. An output data of the FF 24b is selected by the selector 27, output to the terminal BSOUT and then supplied to a terminal BSIN of a boundary scan register in a subsequent stage. The data stored in the FFs 24a and 24b are output to terminals DEC0 and DEC1, respectively.

When the Public instructions are configured in the instruction register the TAP controller 30 outputs both the SET_IPM signal and the MODE_IPM signal in low level. At this time the first boundary scan path FT1 is selected and functions as a conventional circuit.

The boundary scan register circuit 10 constructed as above mentioned can both carry out a conventional general JTAG test and configure (set) the configuration data for the IO circuit. And also it can transmit test patterns serially without destroying the data stored in the FFs 24a and 24b at the JTAG text.

If there is no need to initialize the FF 24a and 24b using the SET_IPM signal, the SET_IPM signal can be omitted. When the SET_IPM signal is emitted the gate circuit 25 outputs a logical output ClockDR×MODE_IPM. However, even in case the SET_IPM signal is omitted it is possible to switch the first boundary scan path PT1 or the second boundary scan path PT2 in the boundary scan register circuit 10 by the MODE_IPM signal.

The FFs with set functions are illustrated as the FFs 24a and 24b in FIG. 1A, however, it is possible to use FFs with reset functions as the FFs 24a and 24b, and initialize each output into 0 of the FFs 24a and 24b for storage of the configuration data by the SET_IPM signal when the SET_IPM signal is set high level. This means that it is possible to change the boundary scan register circuit configuration without transmission of a configuration data when the circuit is initialized by using set or reset FFs for the FFs 24a and 24b.

Next a case to use the second boundary scan path to configure the configuration data for the IO circuit is explained. At first a low level signal is input to the terminal TRST connected to the TAP controller 30 in FIG. 1B, then the SET_IPM signal becomes high level and both the FFs 24a and 24b are initialized. The FFs 24a and 24b are set “1” and the configuration values are output from the terminals DEC0 and DEC1, to decide the circuit architecture of the ID circuit. In this case either one or both of the FFs 24a and 24b can be replaced by FF with set or FF with reset. In such a case the FF with set outputs high level and the FF with reset outputs low level by the initialization.

As above mentioned, the TAP controller 30 assumes a mode to let the boundary scan register circuit 10 to store the configuration data for the IO circuit when the TAP controller receives “100” (binary number) in the instruction register. The TAP controller 30 outputs the MODE_IPM signal as high level and the SET_IPM signal as low level at this mode. The second boundary scan path FT2 is selected instead of the first boundary scan path PT1 by the selector 27 by setting the MODE_IPM signal high level. On the other hand, by setting the SET_IPM signal low level, a supply of clock signal to the FF 21 incorporated in the first boundary scan path PT1 is stopped by the gate circuit 26 (the clock signal is fixed to 0) and the clock signal is supplied to the FFs 24a and 24b by the gate circuit 25. As a result, data supplied from the terminal BSIN is transmitted to the FFs 24a and 24b serially at a timing of rising edge of the ClockDR signal. The output of the FF 24b is output to the terminal BSOUT by the selector 27 and supplied to the terminal BSIN of the boundary scan register of the latter stage. The data in the FFs 24a and 24b of the second boundary scan path PT2 is stored in this way. And also a circuit architecture of the IO circuit connected to the boundary scan register circuit is configured by the output signals of the terminals DEC0 and DEC1, which are outputs of the FFs 24a and 24b. Whenever the data is stored in the second boundary scan path the data in FF21 is kept reserved since the output level of the gate circuit 26 is kept low as aforementioned.

Next a function of the boundary scan register at the JTAG test is described. The SET_IPM signal and the MODE_IPM signal are set low level when the Public instruction is stored in the instruction register. And when the level of the ShiftDR signal is low, data from the terminal Input is stored in the FF 21 at a timing of rising edge of the ClockDR signal and when the level of the ShiftDR signal is high, data from the terminal BSIN is stored in the FF 21. An output of the FF 21 is supplied to the terminal BSOUT via the selector 27 and further input to the terminal BSIN of the boundary scan register of a subsequent stage. Because the level of the MODE_IPM signal is low at this time, an output of the gate circuit 25 is constantly low and consequently the data input from the terminal BSIN is not transmitted to the FFs 24a or 24b.

A semiconductor integrated circuit device of the present invention is controlled so that when the first boundary scan path PT1 is selected the ClockDR signal is not supplied to the FFs making up the second boundary scan path PT2, and when the second boundary scan path PT2 is selected the ClockDR signal is not supplied to the FFs making up the first boundary scan path PT1.

The semiconductor integrated circuit device according to an example of the present invention comprises a boundary scan register circuit for the JTAG test, and the boundary scan register circuit contains two paths, a boundary scan path (PT1) used for test data transmission for the JTAG test and a path (PT2) used for data transmission for configuration of an IO circuit, within its circuit. And the circuit is constructed so that each path can be selected by control signals output by the TAP controller 30. This structure makes it possible to select the path for the configuration register of the IO circuit or the scan path for the test data of the JTAG test as necessary. Therefore, it is possible to reduce the resources of an external memory for storage of a configuration data for an IO circuit or the volume of data for test patterns. In addition there is a great advantage that the structure does not need a large change of a conventional design method because the BSR itself is constructed to be able to select two routes of scan paths and it is possible to replace a conventional BSR with the BSR of the present invention.

A semiconductor integrated circuit device comprising a boundary scan register circuit 10 of the present invention is described in more detail with reference to examples. Although it is not shown in Figures, it is presumed that the tap controller 30 or a similar circuit is provided with the device.

### EXAMPLE 1

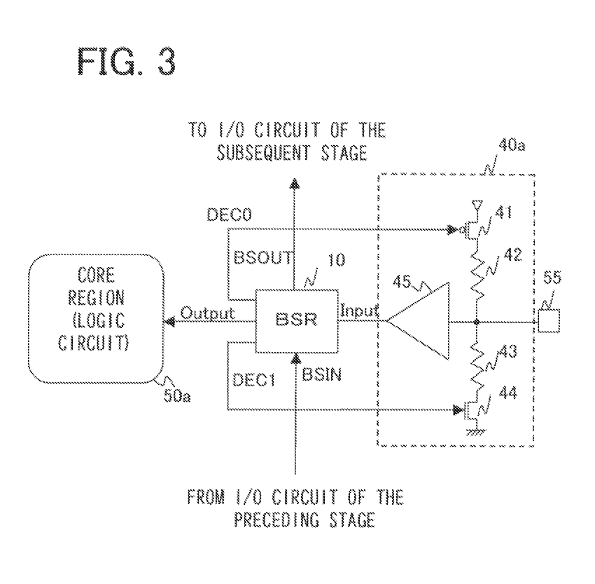

FIG. 3 shows a block diagram illustrating a structure of a first example of a semiconductor integrated circuit device of the present invention. The semiconductor integrated circuit device according to FIG. 3 is an example applying an input circuit 40a as an IO circuit and has one boundary scan register circuit BSR 10 corresponding to the input circuit 40a. The input circuit 40a includes a terminator (terminator resistor) 42 located between power supply and a pad 55, a terminator 43 located between the ground and the pad 55, an input buffer 45 and switch elements 41 and 44. The switch element 41 of PMOS transistor and the switch element 44 of NMOS transistor have a role to switch whether each of the terminators 42 and 43 is connected to the power supply and the ground, respectively. Each of control terminals of the switch elements 41 and 44 is connected to terminals DEC0 and DEC1 of the boundary scan register circuit 10, respectively. An input of the input buffer 45 is connected to the pad 55 and an output of the input buffer 45 is connected to a terminal “Input” of the boundary scan register circuit 10. A terminal “Output” of the boundary scan register circuit 10 is connected to a core region (logic circuit) 50a.

A semiconductor integrated circuit device of such a structure can switch connection states of the terminators 42 and 43 and change a circuit architecture of the input circuit 40a by controlling the switch elements 41 and 44 on and off based on a configuration data of the input circuit 40a set in the FFs 24a and 24b of the boundary scan register circuit 10.

### EXAMPLE 2

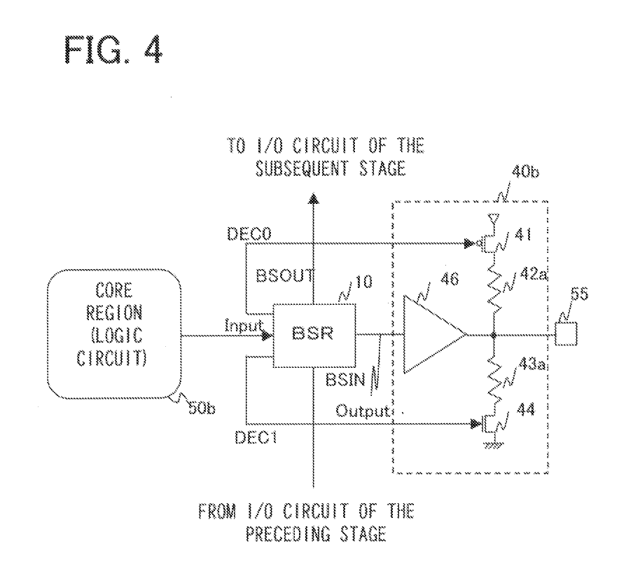

FIG. 4 shows a block diagram illustrating a structure of a second example of a semiconductor integrated circuit device of the present invention. The semiconductor integrated circuit device according to FIG. 4 is an example applying a 2-state output circuit 40b as an IO circuit and has one boundary scan register circuit 10 corresponding to the 2-state output circuit 40b. The 2-state output circuit 40b includes a pullup resistor 42a located between power supply and a pad 55 as an output terminal, a pulldown resistor 43a located between the ground and the pad 55, an output buffer 46 and switch elements 41 and 44. The switch element 41 of PMOS transistor and the switch element 44 of NMOS transistor have a role to switch whether each of the pullup resistor 42a and pulldown resistor 43a is connected to the power supply and the ground, respectively. Each of control terminals of the switch elements 41 and 44 is connected to terminals DEC0 and DEC1 of the boundary scan register circuit 10, respectively. An output from a core region (logic circuit) 50b is connected to a terminal “Input” of the boundary scan register circuit 10 and a terminal “Output” of the boundary scan register circuit 10 is connected to an input of an output buffer 46. An output of the output buffer 46 is connected to the pad 55 as an output terminal.

The semiconductor integrated circuit device of such a structure can switch connection states of the pullup resistor 42a and pulldown resistor 43a and change the circuit architecture of the 2-state output circuit 40b by controlling the switch elements 41 and 44 on and off based on a configuration data of the 2-state output circuit 40b set in the FFs 24a and 24b of the boundary scan register circuit 10.

### EXAMPLE 3

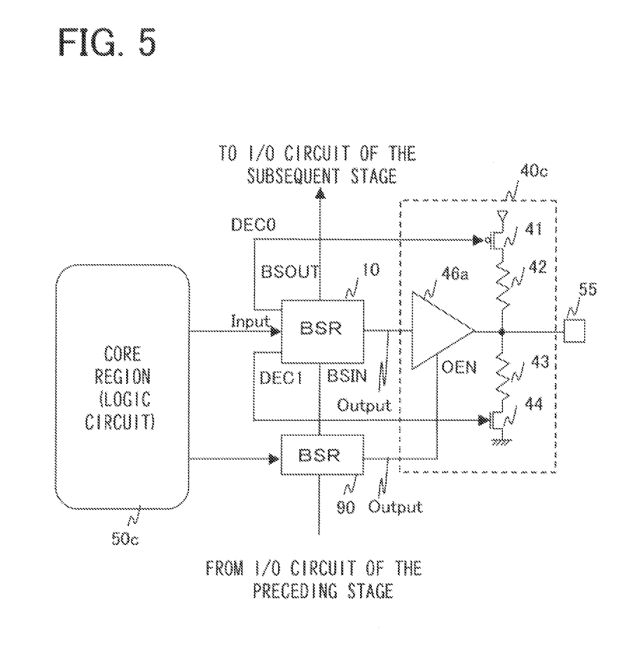

FIG. 5 shows a block diagram illustrating a structure of a third example of a semiconductor integrated circuit device of the present invention. The semiconductor integrated circuit device according to FIG. 5 is an example applying a 3-state output circuit 40c as an IO circuit and constructs a boundary scan path provided with one boundary scan register circuit 10 and one conventional boundary scan register circuit 90 corresponding to the 3-state output circuit 40c. The structure of the circuit device of FIG. 5 is the same as that of FIG. 4 except that the circuit device of FIG. 5 has a 3-state output buffer 46a and an enable terminal OEM of the 3-state output buffer 46a is connected to an output terminal “Output” of the boundary scan register circuit 90. The boundary scan register circuit 10 of the present invention can be constructed with the conventional boundary scan register circuit 90 as this example.

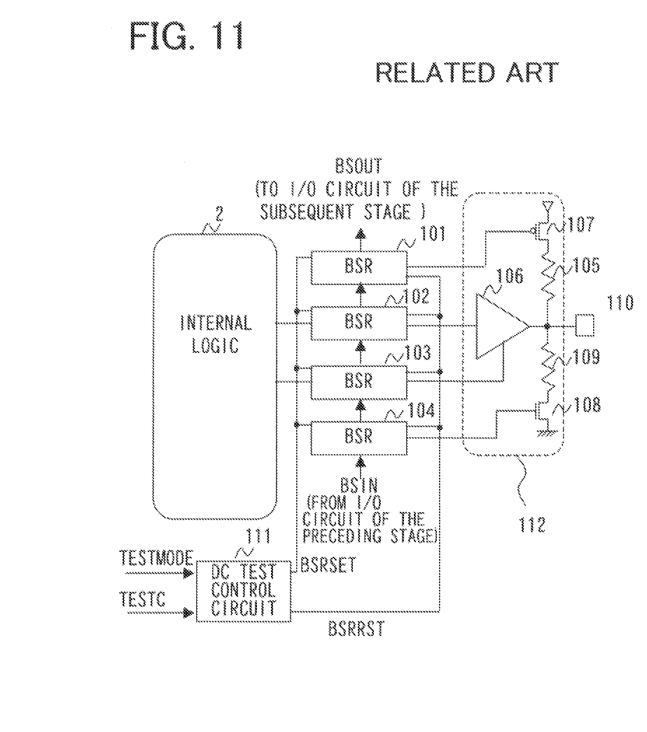

A programmable circuit to change values for a pullup resistor and a pulldown resistor using a conventional circuit is shown in FIG. 11 and FIG. 5 shows a case using the boundary scan register of the present invention. A single boundary scan path is constructed by both the boundary scan register circuit 10 of the present invention and the conventional boundary scan register 90 in FIG. 5. That is, registers for data configuration (setting) for the test and registers (FFs) for the configuration of the IO circuit are completely separated in the scan path. Therefore, it becomes possible to carry out the JTAG test and the configuration of the circuit using a minimum volume of data, respectively.

Here in Example 3, it is no regarded as configuration of the circuit to set an output of the 3-state output buffer 46a High-Z (high impedances state by the enable terminal OEN. In case of an IO circuit which is regarded as the configuration of the circuit, the conventional boundary scan register circuit 90 can be merely replaced by the boundary scan register circuit 10 of the present invention.

### EXAMPLE 4

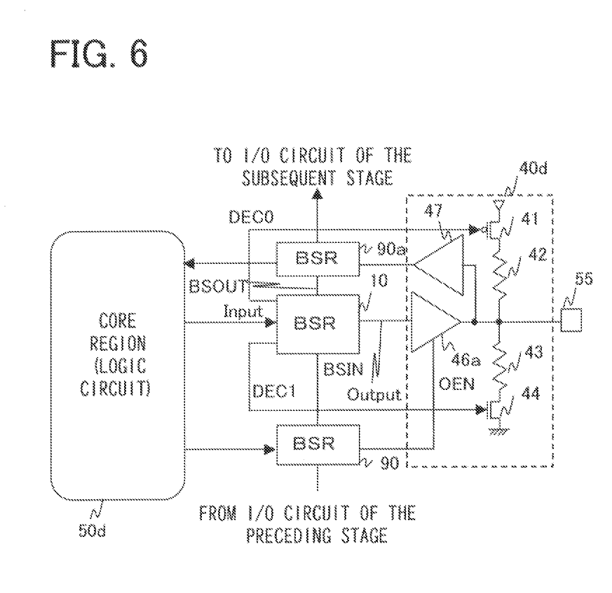

FIG. 6 shows a block diagram illustrating a structure of a fourth example of a semiconductor integrated circuit device of the present invention. The semiconductor integrated circuit device according to FIG. 6 is an example applying a bi-directional buffer 40d as an IO circuit and constructs a boundary scan path provided with one boundary scan register circuit 10 and two conventional boundary scan register circuits 90 and 90a corresponding to the bi-directional buffer 40d. The bi-directional buffer 40d is the same structure as the 3-state output circuit 40c except that the bi-directional buffer 40d has an additional input buffer 47. An input of the boundary scan register circuit BSR. 90a is connected to an output of the input buffer 47 and an output of the boundary scan register circuit 90a is connected to a core region (logic circuit) 50d. The number of the FFs for storage of configuration data in the boundary scan register circuit 10 can be changed in connection with types of input/output buffers.

In case of a structure of the boundary sears path with the boundary scan register circuit 10 and the conventional boundary scan register circuits 90 and 90a, shown in FIG. 6, register(s) for data configuration for the test and registers (FFs) for configuration of an IO circuit are not completely separated in the scan path. However, registers for data configuration for the test and registers (FFs) for configuration of an IO circuit can be constructed as separated scan paths in the boundary scan register circuit 10. Therefore, the volume of data for the test (a number of test patterns) can be reduced.

### EXAMPLE 5

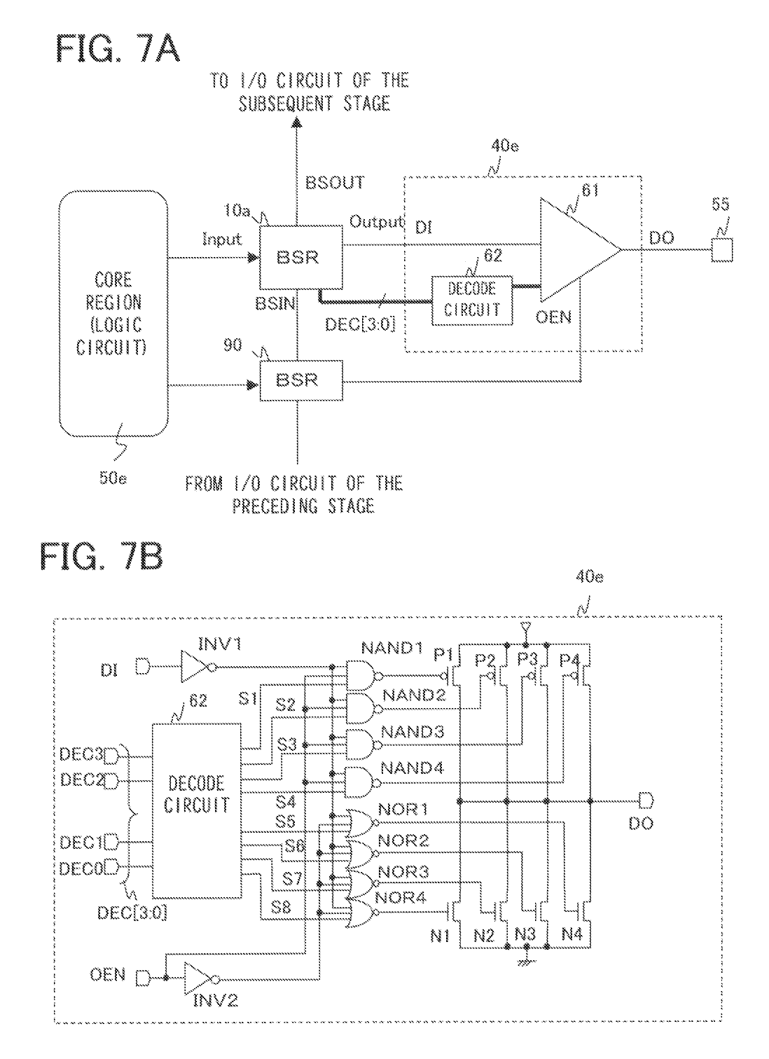

FIGS. 7A and 7B show block diagrams illustrating a structure of a fifth example of a semiconductor integrated circuit device of the present invention. The semiconductor integrated circuit device according to FIGS. 7A and 7B are an example applying an output impedance control buffer 40e to a boundary scan register circuit 10a of the present invention and a conventional boundary scan register circuit 90. The boundary scan register circuit BSR 10a is so constructed that two FFs (FF 24c and FF 24d, not shown) are added after the FF 24b of the boundary scan register circuit 10 of FIG. 1A and the output of the FF24d is connected to the selector 27. Where, the FF 24c is connected next to the FF 24b and the FF 24d is connected next to the FF24c in the scan path and so on, and an output of the FF 24c is connected to a terminal DEC2 while an output of the FF 24d is connected to a terminal DEC3. That is, the boundary scan register circuit 10a is provided with 4-bit. FFs for configuration of an IO circuit.

The output impedance control buffer 40e includes an output buffer 61 and a decord circuit 62. And a circuit architecture of the output buffer 61 is controlled by output signals from terminals DEC0, DEC1, DEC2 and DEC3 (they are denoted together also as DEC [3:0] in FIGS. 7A and 7B) of the boundary scan register circuit 10a.

FIG. 7B shows a block diagram illustrating a structure of the output impedance control buffer 40e. The output impedance control buffer 40e has the decord circuit 62, inverter circuits INV1 and INV2, NAND circuits NAND1 to NAND 4, NOR circuits NOR1 to NOR 4, Pch transistors P1 to P4 and Nch transistors N1 to N4.

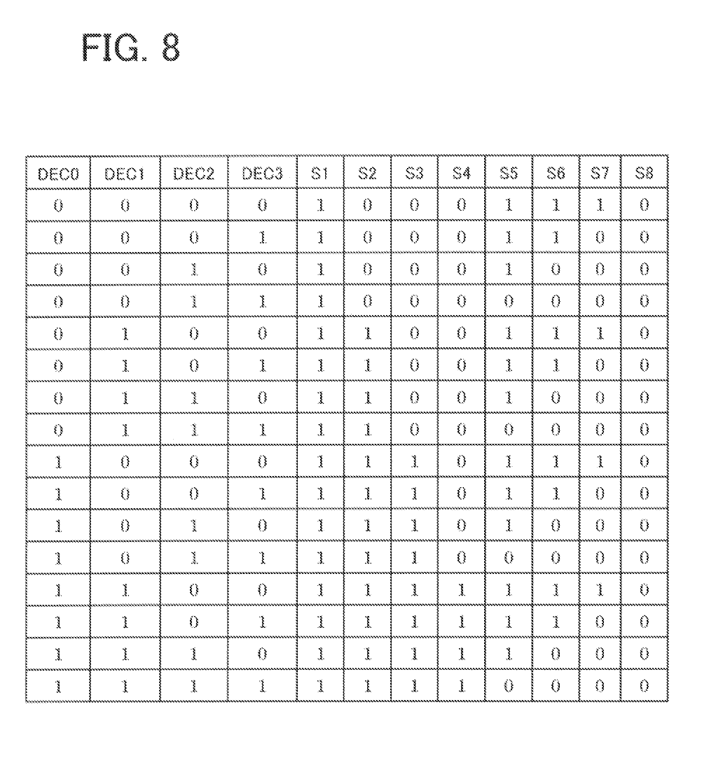

FIG. 8 shows a diagram of a logic level example of decord output of the decord circuit 62. Output levels of impedance control signals S1 to S8 are changed by setting logic levels of the terminals DEC0, DEC1, DEC2 and DEC3, as shown in FIG. 8. It is possible to change the number under operation of the Pch transistors P1 to P4 and Nch transistors N1 to N4 of the output buffer 61 according to the output levels of the impedance control signals S1 to S8. The output impedance of the output buffer 61, which is controllable by configuration of the terminals DEC0, DEC1, DEC2 and DEC3, can be configured by the output impedance control buffer 40e of such a structure.

When an enable signal OEN is 1, it enables the output buffer 61 and when an enable signal OEN is 0, it disenables the output buffer 61. Each signal to control gates of the Pch transistors P1 to P4 is generated by the NAND circuits NAND1 to NAND4 to operate NAND of an inverted signal of a signal D1 inverted by the inverter circuit INV1, each of the impedance control signals S1 to S4 and the enable signal OEN. And each signal to control gates of the Nch transistors N1 to N4 is generated by the NOR Circuits NOR1 to NOR4 to operate NOR (logical sum) of the inverted signal of the signal D1 inverted by the inverter circuit INV1, each of the impedance control signals S3 to S8 and an inverted signal of the enable signal OEN by the inverter circuit INV2. The enable signal OEN in FIGS. 7A and 7B are also supplied by the conventional boundary scan register circuit 90. Sources of the Pch transistors P1 to P4 are connected to a power supply and sources of the Nch transistors N1 to N4 are connected to the ground. Drains of both the Pch transistors P1 to F4 and Nch transistors N1 to N4 are common, respectively, and output a signal DO to the pad 55.

According to the structure of FIGS. 7A and 7B, it is possible to control drivability of the buffer as well as connections of pullup resisters and pulldown resistors by the software (circuit) by controlling on or off of the Pch transistors P1 to P4 and Nch transistors N1 to N4. In addition, in case where many control signals from the boundary scan register circuit 10a are necessary for the control of the drivability of the buffer, it is also possible to control the drivability of the buffer with minimum control signals by using the decorder circuit 62 as shown in FIGS. 7A and 7B. That is to say, serial transmission of data from the boundary scan chain to FFs can be achieved by providing four FFs to store circuit configuration data in the boundary scan register circuit 10a and connecting the outputs of the FFs to the dee-order circuit 62 of the buffer. It is also possible to construct the circuit so that desired decorder values are input to the decorder circuit at a time of initialisation by a combination of set FFs and reset FFs when the desired decorder values are known previously.

The conventional boundary scan register circuits 90, 90a and the boundary scan register circuits 10 and 10a of the present invention described in the examples above are in a through mode when the Model signal is 0 (which can be set by the TAP controller), that is, a normal operation mode. And they function to connect a logic circuit of a core region and an IO circuit directly in the through mode. When carrying the JTAG test, the boundary scan register circuits 90, 90a, and those of the present invention 10 and 10a transmit data from FF (FF 22 in FIG. 1A, for instance) and receive data to FF (FF 21 in FIG. 1A, for instance) using the first scan path of the circuit.

It is possible to select one of two paths in the boundary scan of the present invention by control signals as previously described. When switched to a path for the JTAG test, the circuit construction is almost the same as a conventional boundary scan and there is no need to change drastically the conventional design method for the JTAG test.

### EXAMPLE 6

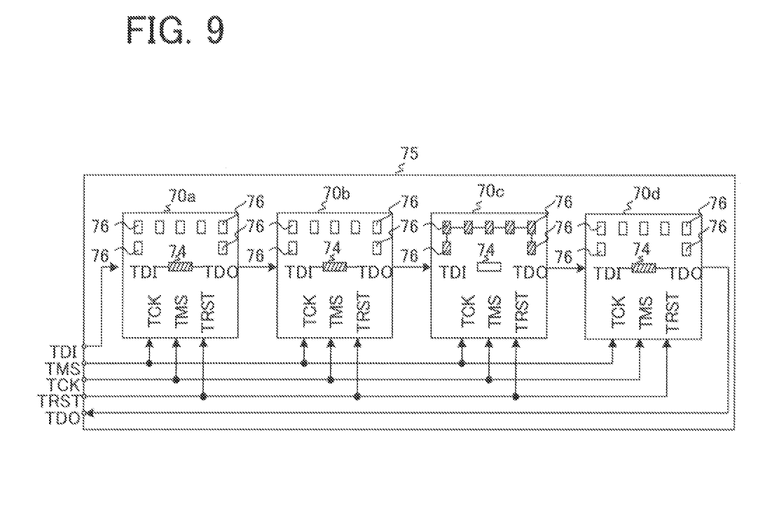

FIG. 9 shows a block diagram illustrating a structure of an electronic device according to an example of the present invention. Semiconductor integrated circuit devices 70a, 70b, 70c and 70d are implemented on a printed circuit board (PCB) 75 in FIG. 9. Each of the semiconductor integrated circuit devices 70a, 70b, 70c and 70d is provided with a BYPASS register 74 and boundary scan registers 76. The BYPASS register 74 corresponds to the FF 21 in FIG. 1A and the boundary scan registers 76 correspond to the FFs 24a and 24b in FIG. 1A. A method to transmit circuit configuration data to the semiconductor integrated circuit device 70c on the printed circuit board 75 with the semiconductor integrated circuit devices 70a, 70b, 70c and 70d is explained below.

At first, the instruction code BYPASS shown in FIG. 2 is sent to instruction registers (not shown) of the semiconductor integrated circuit devices 70a, 70b and 70d, and the instruction code PROGRAM in FIG. 2 is sent to an instruction register of the semiconductor integrated circuit device 70c. Then the semiconductor integrated circuit devices 70a, 70b and 70d receive data input from a terminal TD1 of each device not in the boundary scan registers but in the BYPASS registers 74 to output the data to a terminal TDO of each device at timing of a rising of a ClockDR signal. In this state, circuit configuration data for the semiconductor integrated circuit device 70c is transmitted serially to the semiconductor integrated circuit device 70c from the terminal TD1 of the PCB 75 and is stored in the boundary scan registers 76 of the semiconductor integrated circuit device 70c. It becomes possible by the data transmission described above to change the circuit architecture of an IO portion of the semiconductor integrated circuit device 70c on the PCB 75 implemented with the semiconductor devices.

The circuit configuration data transmitted to the semiconductor integrated circuit device 70c simply pass through the BYPASS registers 74 in the semiconductor integrated circuit devices 70a, 70b and 70d in electronic apparatus of this structure. Therefore, the volume of configuration data transmitted from the outside can be reduced and it also makes transmission time relatively short.

It should be noted that other objects, features and aspects of the present invention will become apparent in the entire disclosure and that modifications may be done without departing the gist and scone of the present invention as disclosed herein and claimed as appended herewith.

Also it should be noted that any combination of the disclosed and/or claimed elements, matters and/or items may fail under the modifications aforementioned.

What is claimed is:

1. A semiconductor integrated circuit device comprising:
a plurality of boundary scan register circuits which comprises:
a first register to store data for a boundary scan;
a second register to store configuration data for an architecture of an IO circuit connected to an external terminal; and
a selection circuit that selectively outputs one of data output from said first register and said second register,
wherein said boundary scan register circuit receives data output from said boundary scan register circuit of a preceding stage, inputs said data into said first and said second registers, and outputs data outputted from said selection circuit into said boundary scan register circuit of a subsequent stage.

2. The semiconductor integrated circuit device as defined in claim 1, wherein said selection circuit selects input data based on an operation mode signal.

3. The semiconductor integrated circuit device as defined in claim 2 comprising a test control circuit that controls said first and said second registers and said selection circuit, wherein a transition state of said test control circuit is changed based on an external control signal, and said test control circuit generates an operation clock signal for said first and said second registers and said operation mode signal based on said changed transition state.

4. The semiconductor integrated circuit device as defined in claim 3, wherein said test control circuit functions such that when said first register is selected, said test control circuit does not supply said operation clock signal to said second register, and when said second register is selected, said test control circuit does not supply said operation clock signal to said first register.

5. The semiconductor integrated circuit device as defined in claim 4, wherein said test control circuit further generates an initializing signal, and
said second register is initialized so as to output a predetermined output signal by said initializing signal.

6. The semiconductor integrated circuit device as defined in claim 1 comprising a terminator resistance for said external terminal, wherein a connection of said terminator resistance for said external terminal is controlled based on said output data of said second register.

7. The semiconductor integrated circuit device as defined in claim 1, wherein said IO circuit comprises an output circuit having a variable drivability, and said drivability of said output circuit is set based on said output data of said second register.

8. The semiconductor integrated circuit device as defined in claim 7, wherein said output circuit comprises a decoder circuit that decodes said output data of said second register, and said drivability of said output circuit is set by a plurality of output driver transistors which constitute said output circuit and are operated selectively by a decoder output signal from said decoder circuit.

9. An electronic apparatus comprising:
a printed circuit board comprising at lease one of said semiconductor integrated circuit device of claim 1, wherein configuration data for an architecture of an IO circuit connected to said semiconductor integrated circuit device is input from a data input terminal of said printed circuit hoard,
a boundary scan register circuit present in a circuit of a path on a side of said data input terminal of said semiconductor integrated circuit device is set a bypass-state, and
said data is transmitted to said second register in said semiconductor integrated circuit device.
